(19) United States
(12) Patent Application Publication
(10) Pub. No.: US 2012/0161497 A1
(43) Pub. Date: Jun. 28, 2012

(54) WHEEL HUB FLYWHEEL-MOTOR KINETIC HYBRID SYSTEM AND METHOD

(76) Inventors: Jing He, Burbank, CA (US); Hongping He, Bakersfield, CA (US)

(21) Appl. No.: 13/341,392

(22) Filed: Dec. 30, 2011

(51) Int. Cl. B60K 7/00

(52) U.S. Cl. 301/6.5

(57) ABSTRACT

System and method for the combination of a flywheel and motor/generator inside a wheel hub for hybrid vehicle propulsion. The flywheel and motor/generator are connected by a planetary gear system, in which a first port is connected to the flywheel, a second port is connected to the wheel hub, and a third port is connected to a motor/generator. An additional motor/generator may be used at one of the first port and second port. The system may be used in an electric-kinetic hybrid mode, or in a fuel-kinetic hybrid mode, when used in a vehicle having an internal combustion engine as the prime mover. Efficiency of energy storage and release is significantly improved in comparison to prior art.

### BACKGROUND OF THE INVENTION

1. Field of the Invention

This invention pertains to a system and method for a combination of a flywheel and motor/generator(s) contained within a wheel hub used for hybrid vehicle propulsion. The system may be used in conjunction with electric vehicles for an electric-kinetic hybrid vehicle, or used in conjunction with vehicles powered by internal combustion for a fuel-kinetic hybrid vehicle.

2. Description of the Related Art

Traditional electric vehicles and electric hybrid vehicles face the same set of challenges and/or limitations. First, because energy is stored in a chemical form in batteries, which differs from the mechanical, kinetic form of energy the vehicle ultimately uses, the energy stored and reused must undergo several stages of conversion. From mechanical to electric, from electric to chemical, from chemical to electric, and from electric to mechanical again, a typical path for reusing energy recovered from regenerative braking, the energy undergoes four conversions, resulting in significant energy losses due to conversion. Only a small portion of regenerated energy can be reused, which limits the efficiency of electric vehicles and hybrids. Second, the power density of both motor/generators and batteries are not high enough, which restricts vehicle performance and acceleration. Moreover, with current battery technologies, battery life is a significant consideration; since the number of charge/recharge cycles the battery can undergo is limited, this results in a need to replace the battery pack after some time, adding to the cost of owning the hybrid vehicle. Additionally, for electric vehicles, the distance the vehicle can travel per charge is relatively short.

Flywheel hybrids, as known as kinetic hybrids, are an alternative to electric hybrids. There exist mechanical continuously variable transmissions to control the storage and release of energy in a flywheel hybrid vehicle, but these mechanical CVTs suffer low efficiency at a high transmission ratio. There are also electromagnetic means to transfer energy in and out of the flywheel; however, these methods emphasize using the flywheel solely as energy storage. Demanding high energy capacities in the flywheel necessitates high flywheel speeds, which adds safety issues, not to mention that the energy in the flywheel is not used during cruise. More importantly, using electromagnetic means to control the transfer of energy to and from the flywheel makes it so that 100 percent of the energy stored into the flywheel must undergo conversion, limiting efficiency. The prior art has not sufficiently used the advantages of the flywheel while avoiding its disadvantages for flywheel hybrids to be industrially competitive.

### SUMMARY OF THE INVENTION

The system and method of the present invention improve the vehicle's efficiency and performance by making full use of the flywheel's advantages such as high power density and the fact that the energy stored is in the same form it is to be used in, while at the same time avoiding such disadvantages as having low energy density without resorting to special materials. The flywheel may be designed to contain only the amount of energy necessary to accelerate the vehicle to a certain speed, so it may be designed to be lightweight and safe. The invention uses a three port planetary gear system and motor/generator(s) to form an electrically controlled continuously variable transmission to store and release energy to and from the flywheel. By planetary gear system, the present invention refers to both traditional mechanical planetary gear sets and magnetic planetary gears. The flywheel, motor/generator, and planetary gear system with three ports may all be contained within a wheel hub. The three ports of the planetary gear system are respectively connected to the flywheel, the variator for the flywheel, and the wheel containing the planetary gear system. Another motor/generator may be connected to either the flywheel or the vehicle's wheel to form a power split system. Changing the speed of one port on the planetary gear system with the variator for the flywheel changes the speeds of the other two ports, enabling a change in the speed ratio between the other two ports to allow the flywheel and the vehicle to directly exchange kinetic energy. Functionally, then, the flywheel is not only used for energy storage (like a battery pack) but also as a power source (like a traction motor). The system of the present invention therefore includes a kinetic power source, an electric power source, and a kinetic energy storage. Additionally, if the system is used within a vehicle with an internal combustion engine, the vehicle can become a fuel-kinetic-electric hybrid vehicle. There are three embodiments for the system of the present invention.

In the first embodiment, the flywheel, a three port planetary gear system, and two motor/generators are in the same wheel hub. A first port of the planetary gear system is connected to the flywheel, a second port is connected to the variator motor/generator, and a third port is connected to the wheel. The second motor/generator, which can use the energy generated by the variator motor/generator back into accelerating the wheel, shares the first port with the flywheel.

In the second embodiment, the flywheel, a three port planetary gear system, and two motor/generators are in the same wheel hub; in the planetary gear system, a first port is connected to the flywheel, a second port is connected to the variator motor/generator, and a third port is connected to the wheel and to the second motor/generator.

In the third embodiment, a flywheel, a three port planetary gear system, and one motor/generator are contained in the same wheel hub; the first port of the planetary gear system is connected to the flywheel, a second port is connected to the variator motor/generator, and a third port is connected to the wheel. A second motor/generator is contained inside a second wheel hub, which is used with the first wheel hub. Although structurally different, the third embodiment is functionally equivalent to the second.

The present invention offers the following advantages over conventional electric vehicles and electric hybrids. The primary improvement over the prior art is in energy efficiency and the reduction of emissions by virtue of improved fuel efficiency. Because the flywheel stores energy in kinetic form, which is the same form of energy the vehicle uses, many energy conversion stages are avoided compared to electric vehicles and electric hybrids, reducing energy losses due to conversion quite significantly. Furthermore, many transmission line losses can be avoided or minimized by installing the flywheel and its variator motor/generator into the wheel hub to directly accelerate the wheel and/or recover energy from the wheel. A second area of improvement is in the vehicle's performance, as the flywheel provides power at a higher power density than either motor/generators or batteries can provide. The power transmitted with the system is greater than the power of the motor/generator, so the vehicle's accelerative performance is improved. Another advantage is that the present invention can reduce the cost of the hybrid vehicle. Because the flywheel is responsible for the majority of the energy stored and released, the vehicle is less dependent on the battery pack, and the rate of charge/discharge as well as the number of charge/discharge cycles can be reduced, extending the battery life, which also reduces the cost of ownership over the life of the vehicle. With the extra power provided by the flywheel, the power requirements on motor/generators and inverter/controllers can be reduced, which also reduces the cost of manufacture. Integrating the flywheel into the wheel hubs of a vehicle makes for more flexibility, which can reduce design costs, so the present invention is also an improvement over flywheel hybrids of the prior art. If the present invention is used in an electric vehicle, it can also increase the vehicle's range per charge because of better efficiency.

### BRIEF DESCRIPTION OF THE DRAWINGS

FIG. 1(a) shows a schematic for the first embodiment of the invention, and FIG. 1(b) is a mechanical drawing of the first embodiment;

FIGS. 2(a) through 2(j) illustrate the method to be used to control the first embodiment;

FIG. 3(a) shows a schematic for the second embodiment of the invention, and FIG. 3(b) is a mechanical drawing of the second embodiment;

FIG. 4(a) shows a schematic for the third embodiment of the invention, and FIG. 4(b) is a mechanical drawing of the third embodiment;

FIGS. 5(a) through 5(j) illustrate the method to be used with the second and third embodiments of the invention;

FIG. 6(a) demonstrates how the first and second embodiments may be used within a vehicle for an electric-kinetic hybrid mode and/or a fuel-kinetic hybrid mode, and FIG. 6(b) demonstrates how the third embodiment may be used within a vehicle for an electric-kinetic hybrid mode and/or a fuel-kinetic hybrid mode;

FIG. 7 shows a planetary gear system using magnetic gearing;

FIGS. 8(a) and 8(b) compare the first embodiment realized respectively via traditional planetary gearing and magnetic planetary gearing;

FIGS. 9(a) and 9(b) compare the second embodiment realized respectively via traditional planetary gearing and magnetic planetary gearing;

FIGS. 10(a) and 10(b) compare part of the third embodiment realized respectively via traditional planetary gearing and magnetic planetary gearing.

### DESCRIPTION OF THE PREFERRED EMBODIMENT(S)

Embodiment(s) of the present invention are described herein with reference to the drawings. In the drawings, like reference numerals represent like elements.

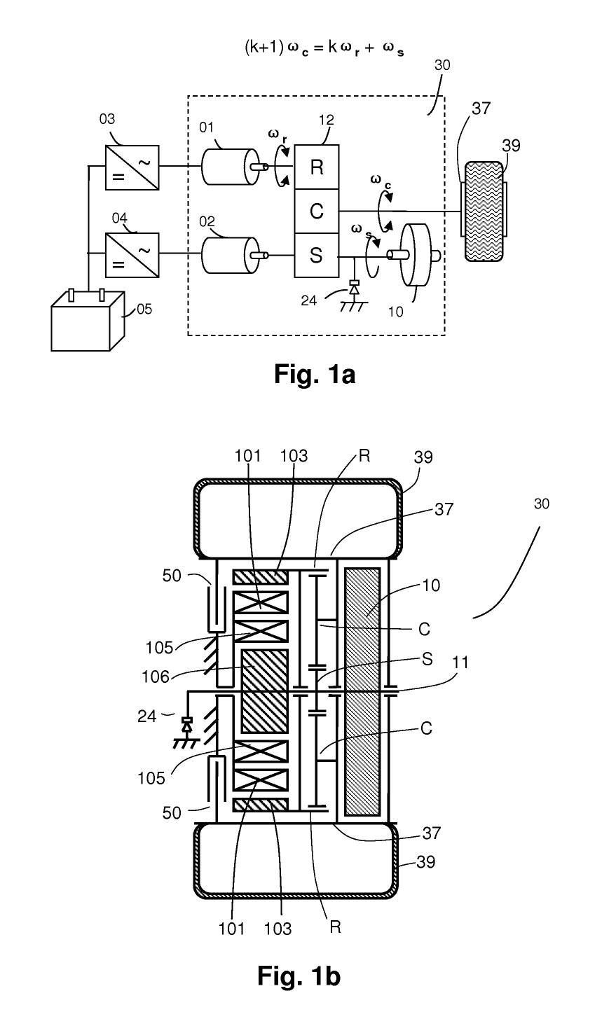

FIG. 1(a) is a schematic for the mechanical components of the first embodiment. The planetary gear set 12 connects the flywheel 10, the motor/generators 01 and 02, as well as the wheel rim 37, into a three port kinetic-electric hybrid power-split system. The first port of the planetary gear set 12 (for instance, the sun gear S) connects to the flywheel 10; the second port (for instance, the ring gear R) connects to the variator motor/generator 01; the third port (for instance, the planet carrier C) connects to the wheel rim 37 inside the tire 39. The other motor/generator 02 shares the first port S with the flywheel 10 and a one-way clutch 24, which prevents the flywheel 10 from rotating in the reverse direction. The primary power source is provided by the motor/generators 01 and 02 powered by the battery pack 05 through the controller/inverters 03 and 04, respectively supplying 01 and 02 with energy. The secondary power source and the secondary energy storage are provided by the flywheel 10.

FIG. 1(b) provides a structural mechanical representation of the first embodiment. The vehicle wheel 39 encloses motor/generators 01 and 02, the flywheel 10, and the planetary gear set 12 (the components inside box 30 in FIG. 1(a)). The rotor 103 of the variator motor/generator 01 is coupled to the ring gear R, and the rotor 106 of the second motor/generator 02 is coupled to the sun gear S and the flywheel 10. The planet carrier gear C is connected to the wheel rim 37. Connected to the central shaft 11 is the one-way clutch 24, which prevents the flywheel 10 from rotating in the reverse direction. 50 is the mechanical brake. The stator 101 of the motor/generator 01 and the stator 105 of the motor/generator 02 are connected to the vehicle chassis. The rotor 103, stator 101, and stator 105 are shaped as concentric rings. The rotor 103 of the motor/generator 01 is on the outer ring outside the stator 101, which is on the inner ring. The motor/generator 02 is contained inside the stator 101, its stator 105 outside its rotor 106. The rotor 106 is connected to the central shaft 11 and thus also connected to the sun gear S and the flywheel 10. To have a motor/generator inside another motor/generator conserves space so as to make it easier and cost-effective to integrate the two motor/generators into the wheel hub, and allows room elsewhere for the battery pack. The wheel containing this embodiment can serve as one of the driving wheels in an electric motorcycle or a hybrid motorcycle.

A suitable control method is also desirable to draw out the benefits that the configuration can offer. In a three port planetary gear set of the mechanical type, the speed relationship between the gears can be expressed by the following equation:

(k+1)ω_{c}=kωᵣ+ωₛ (1)

Here, ω_{c}, ωᵣ and ωₛ are respectively the rotational speeds of the planet carrier gear C, ring gear R and sun gear S, with the constant k being the ratio between the number of teeth in the ring gear R and the number of teeth in the sun gear S. Changing the speed of one port affects the speed of the other ports. The speed of the third port can be determined when the speeds of any two ports are known. The motor/generator 01 and the planetary gear set 12 comprise an electrically controlled continuously variable transmission (CVT) for the flywheel 10. By adjusting the rotational speed and/or rotational direction of the ring gear R, the speed ratio between the sun gear S and the planet carrier gear C can be manipulated. In other words, the variator motor/generator 01 can control the transmission ratio between the flywheel 10 and the vehicle's wheel 39 by changing its own rotational speed and direction.

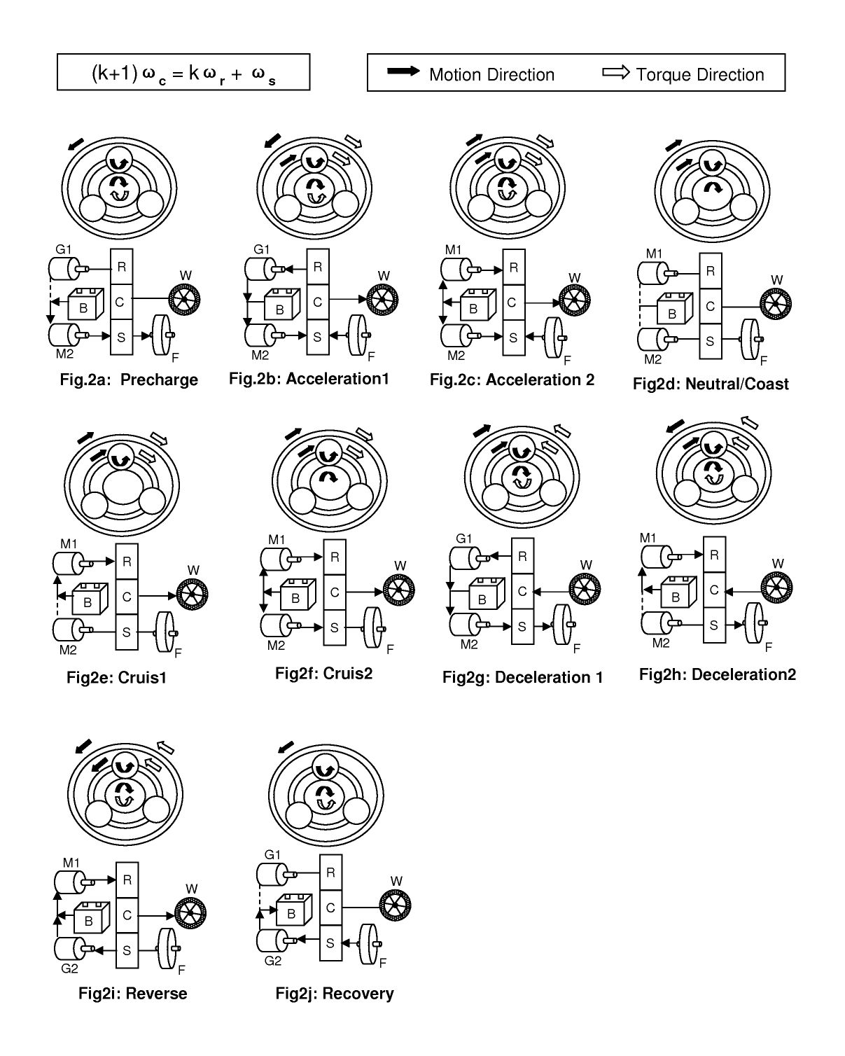

FIGS. 2(a) through 2(j) depict various operation states the kinetic hybrid vehicle using the first embodiment may encounter along a typical journey from starting up the vehicle to parking. In these diagrams, G signifies that the motor/generator depicted is in the generator state, and M indicates the motoring state for the motor/generator. F represents the flywheel 10, W represents the wheel 39, and B represents the battery pack 05. The concentric circles at the top of these diagrams represent the planetary gear set 12 and its constituent ports. These constituent ports are also represented in the boxes below showing connections with other components, with C representing the planet carrier gear, R representing the ring gear, and S representing the sun gear. Thin arrows indicate the direction of energy flow, with thin solid lines indicating that no energy is transferred and dotted lines indicating that the component is decoupled and not in use. For the concentric circles representing the various gears in the planetary gear set 12, thick solid arrows indicate the direction of motion, and thick unfilled arrows indicate the direction of torque.

FIG. 2(a) illustrates the flywheel pre-charge state. In this state, either one motor/generator may be used, or both motor/generators may be simultaneously used to store energy in the flywheel F; M1 should rotate in the counterclockwise (CCW) direction and/or M2 should rotate in the clockwise (CW) direction to rotate the flywheel F in the clockwise direction while the planet carrier gear C is locked in place. What is specifically shown in FIG. 2(a) is the use of the motor M2 to charge the flywheel F. According to Equation (1), if the motor M1 rotates in the CCW direction, the flywheel F rotates in the CW direction, and ωₛ=kωᵣ.

FIG. 2(b) shows the first acceleration state, in which the variator G1 produces torque in the reverse direction of the motion of the ring gear R, and the resulting reaction torque can be transmitted from the flywheel F to the vehicle's wheel W. A portion of the kinetic energy from the flywheel F is directly passed to the wheel W through a direct mechanical path with no conversion loss, and another portion passes through the variator G1, converting to electricity. Because of motor M2, the electricity generated by the variator G1 is not stored to the battery pack B, but is passed to the motor M2 to produce torque in the same direction as the motion of the flywheel F and the sun gear S, so that M2 also contributes to accelerating the wheel W, avoiding two stages of energy conversion (electric to chemical in the batteries, chemical to electric in the motor/generators). Thus with motor M2 efficiency can be increased, battery life can be extended, and accelerative performance can be improved.

FIG. 2(c) illustrates a second acceleration state, in which the direction of torque in the ring gear R is the same as the direction of the ring gear R's motion, at which point the variator M1 is in the motoring state. The combined torques of M1, M2, and the flywheel F contribute an even greater force to accelerate the vehicle.

FIG. 2(d) represents the neutral/coasting state, in which the variator M/G1 is inactive, its rotor rotating freely with the ring gear R. The motor M2 may be inactive like M/G1, or M2 may charge the flywheel F to increase the amount of energy stored, which has no effect on the vehicle speed, since without a torque on the ring gear R there is no energy transfer between the flywheel F and the vehicle.

FIG. 2(e) shows a first cruise state, when only the motor M1 is at work. The motor M2 is inactive. The variator M1 drives the ring gear R in the CW direction, and once the energy in the flywheel F is released to zero, the sun gear S is locked in place by the one-way clutch 24 mentioned earlier, preventing the flywheel F from turning in the reverse direction. Then, the motor M1 can drive the vehicle forward at a transmission ratio of (k+1)/k. There is no more energy stored in the flywheel F, but the motor M2 is available if acceleration is suddenly desired.

FIG. 2(f) depicts a second cruise state. When the cruise speed is set very high, both motors M1 and M2 work to maintain the vehicle speed desired, providing a more suitable CVT ratio. The flywheel F will reach an equilibrium and then stop exchanging energy with the vehicle, serving to steady the vehicle speed desired.

FIG. 2(g) shows a first deceleration and energy recovery state, in which the rotational direction of the ring gear R is the same as the direction of motion for the planet carrier gear C, and the variator G1 produces torque in the reverse direction so as to brake the ring gear R, decelerating the carrier gear C, and accelerating the sun gear S and the flywheel F. A portion of the vehicle's kinetic energy passes through a direct mechanical path to be stored into the flywheel F without conversion. Another portion of the vehicle's kinetic energy passes through the variator G1, and is used immediately by the motor M2 to increase the speed of the flywheel F, hence avoiding charging the battery pack B, and extending the battery life.

FIG. 2(h) illustrates a second deceleration and energy recovery state, in which the rotational direction of the ring gear R is now in the reverse direction of the direction of motion for the planet carrier gear C. The variator M1 is in the motoring state, and accelerates the motion of the ring gear R in the reverse direction, resulting in continued transfer of the vehicle's kinetic energy to the flywheel F until the vehicle speed reaches zero. The motor/generator M2 may be inactive in this state of deceleration.

FIG. 2(i) shows an operation state for driving the vehicle in reverse. The motor M1 drives the ring gear R to rotate CCW, and the generator G2 produces torque against the CW motion of the sun gear S. The result is that the planet carrier gear C rotates in reverse, and thus the wheel W is driven in reverse.

FIG. 2(j) represents an operation state where the energy in the flywheel F is recovered to the battery pack B. Anytime the variator G1 is made inactive by stopping electricity to G1, the ring gear R rotates freely without a torque acting on it, and the vehicle is in a neutral state no matter whether the vehicle is stopped or gliding. Meanwhile, the generator G2 can convert the flywheel F′s kinetic energy to electricity, charging the battery pack B.

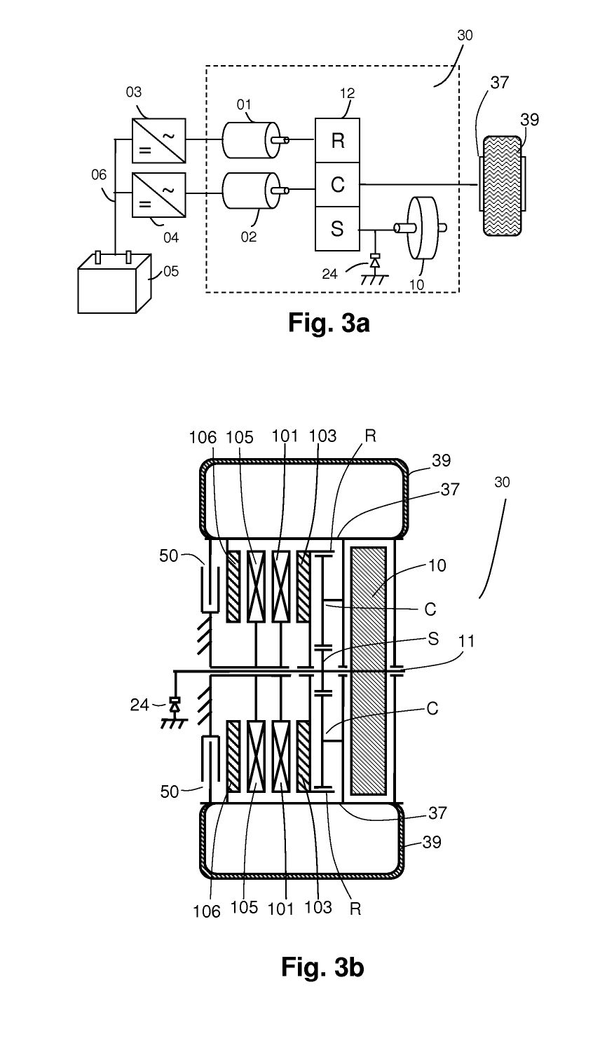

FIG. 3(a) is a mechanical schematic for the second embodiment of the present invention; compared to the first embodiment described above, the motor/generator 02 is now connected to a different port, sharing the planet carrier port C of the planetary gear set 12 with the wheel rim 37. The flywheel 10 is connected to the sun gear S.

A structural mechanical drawing is shown in FIG. 3(b). The motor/generators 01 and 02, along with the flywheel 10 and the planetary gear set 12, are contained within the wheel 39 (all the components contained inside box 30 in FIG. 3(a)). The rotor 103 of the motor/generator 01 is connected to the ring gear R. The rotor 106 of the motor/generator 02 is connected to the wheel rim 37 and the planet carrier gear C. The flywheel 10 is connected to the sun gear S. There is a one-way clutch mechanism 24 connected to the central shaft 11 to prevent the flywheel 10 from rotating in reverse, and a brake 50 is also provided. Both the motor/generators are disc-shaped, connected to the central shaft 11 in parallel. The stator 101 of the motor/generator 01 and the stator 105 of the motor/generator 02 are connected to the vehicle chassis.

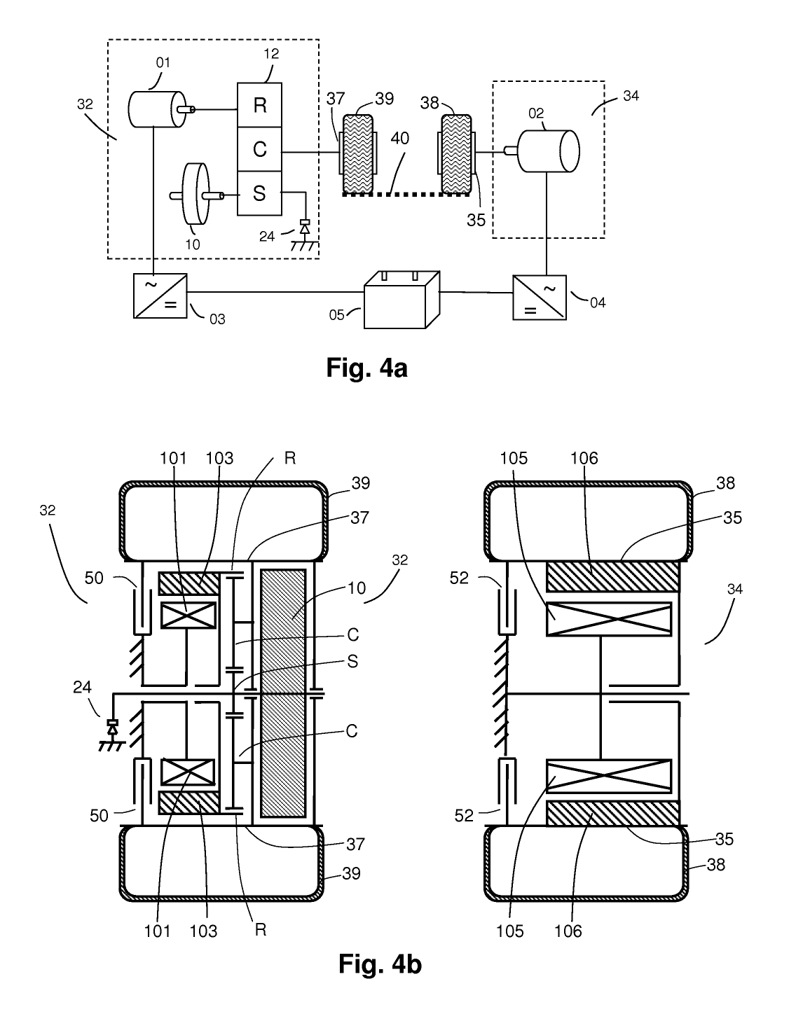

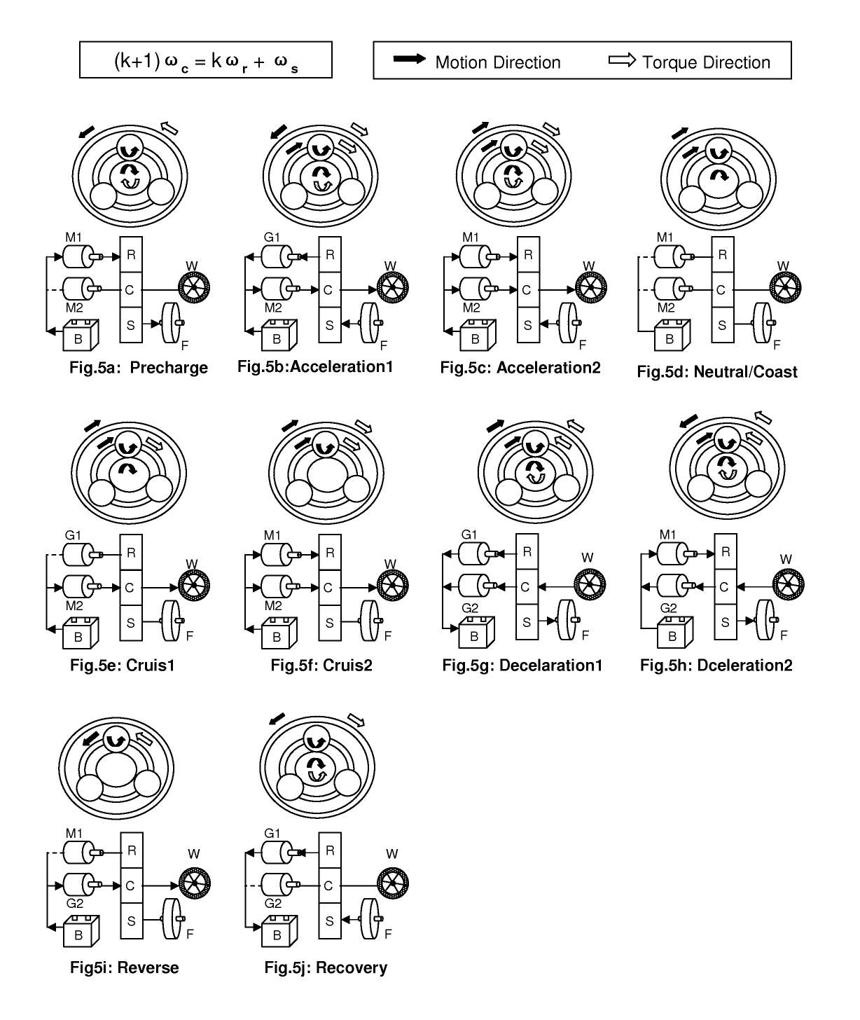

In FIG. 4(a), a schematic of the third embodiment is drawn. The third embodiment is functionally equivalent to the second embodiment, the difference being that the motor/generator 02 is contained within another wheel hub, and the system is thus installed in two wheel hubs instead of just one. The components inside the box 32 are contained within the first wheel hub of the wheel 39, shown in the wheel drawing on the left in FIG. 4(b): the stator 101 of the motor/generator 01 is connected to the vehicle chassis; the rotor 103 is connected to the ring gear R of the planetary gear set 12; the planet carrier gear C is connected to the wheel rim 37; the flywheel 10 is connected to the sun gear S of the planetary gear set 12; the one-way clutch 24 is connected to the central shaft 11 to prevent the flywheel 10 from spinning in the reverse direction; 50 is a mechanical brake. The components inside the box 34 are contained within the second wheel hub of the wheel 38, shown in the wheel drawing on the right in FIG. 4(b): the motor/generator 02 has its stator 105 connected to the vehicle chassis and its rotor 106 connected to the wheel rim 35; 52 represents a brake. Although the two motor/generators are installed in the separate wheels 39 and 38, the rotor 106 of the motor/generator 02 inside the second wheel 39 is functionally connected to the planet carrier gear C on the planetary gear set 12 inside the first wheel 39 because the two wheels 38 and 39 rotate at approximately the same speed on the road surface 40 (see FIG. 4(a)). Thus the third embodiment is conceptually equivalent to the second embodiment. Since these two embodiments are equivalent, the method used to control them, represented in FIGS. 5(a) through 5(j), is the same for both.

FIG. 5(a) illustrates an operation state for pre-charging the flywheel F. When the vehicle is stopped, either prior to starting the vehicle or when the vehicle is stopped for traffic, the wheel is braked, and the planet carrier gear C remains stationary. The motor M1 rotates CCW, and according to Equation (1) the flywheel F spins in the CW direction and stores up the energy from M1.

FIG. 5(b) represents a first acceleration state; the variator G1 produces a torque opposite to the rotational direction of the ring gear R, and the reaction torque enables the transfer of energy from the flywheel F to the wheel W. The kinetic energy from the flywheel F travels via two paths to the wheel(s) W. A portion is passed along a direct mechanical path to the vehicle's wheel(s) W, avoiding any conversion losses, while an other portion of the energy passes through the variator G1, and is then used by the motor M2 to drive the vehicle's wheel(s) W, undergoing two energy conversions from mechanical to electric and then from electric to mechanical. Additionally, the motor M2 may draw more power from the battery pack B as well to drive the wheel(s) W, depending on how much acceleration is desired.

FIG. 5(c) shows a second acceleration state. When the direction of rotational motion of the ring gear R becomes the same and the direction of torque produced by the variator M1, M1 operates as a motor. The motor/generators M1, M2 combine their torque with that of the flywheel F to accelerate the vehicle.

In FIG. 5(d), both motor/generators M1 and M2 are inactive, so the vehicle is in a neutral state or coasting state.

FIG. 5(e) illustrates a first cruise state. The variator G1 is off, and the ring gear R rotates freely; the status of the flywheel F is unchanged because there is no torque on the ring gear R; the motor M2 alone drives the vehicle to maintain the desired vehicle speed.

FIG. 5(f) illustrates a second cruise state. When there is significant resistance encountered (such as driving up a hill), both the motor/generators M1 and M2 work to drive the vehicle, and the energy in the flywheel F can be completely released to zero.

FIG. 5(g) presents a first deceleration and energy recovery operation state. When the ring gear R rotates in the same direction as the planet carrier gear C, the variator G1 produces torque opposite to the direction of motion of the ring gear R, reducing its speed, which results in the deceleration of the planet carrier gear C and the acceleration of the flywheel F. The vehicle's kinetic energy travels a mechanical path to the flywheel F without energy conversion. The generator G2 can convert the vehicle's kinetic energy to electricity and charge the battery pack B.

FIG. 5(h) illustrates a second deceleration and energy recovery operation state. By the time the motion of the ring gear R is reduced to zero and the ring gear R starts rotating in the direction opposite to the motion of the planet carrier gear C, the generator G2 provides electricity to the motor M1 to further drive the ring gear R to rotate in the reverse direction, thus inducing the vehicle's kinetic energy to be continued to be charged into the flywheel F, until the vehicle speed reaches zero.

FIG. 5(i) shows an operation state for reversing the vehicle; the motor M2 drives the planet carrier gear C in the reverse direction. The motor M1 is inactive.

In FIG. 5(j), the system recovers excess kinetic energy in the flywheel F to electricity to charge the batteries with the generator G1 after the vehicle's wheel(s) W (and the planet carrier gear C) has/have been braked.

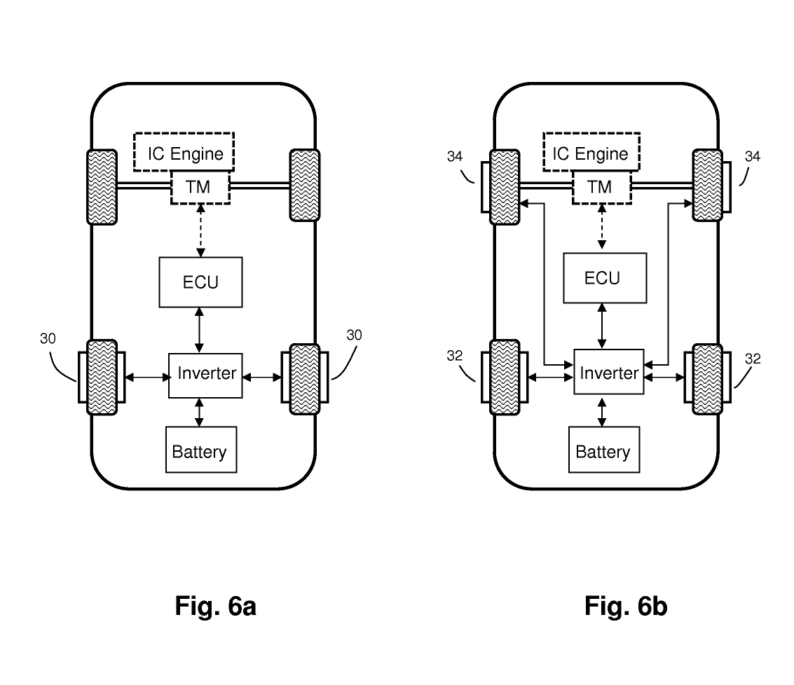

FIGS. 6(a) and 6(b) demonstrate how the present invention may be integrated into an existing vehicle for vehicle propulsion. Used with an ECU, inverter, and battery pack in the vehicle's powertrain, the system of the present invention transforms the vehicle into a kinetic-electric hybrid. Used with an internal combustion engine and transmission in the vehicle's powertrain, the system of the present invention transforms the vehicle into a fuel-kinetic-electric hybrid. In particular, the arrangement depicted in FIG. 6(a) is suitable for use with the first and second embodiments, which both contain the motor/generators in the same wheel hub; as illustrated, the first and second embodiments comprise all the components represented by 30 in FIG. 1(a) and FIG. 3(a), respectively, and in FIG. 6(a) two of the same configuration 30 are used in the vehicle. Using a pair of wheels with the configuration 30 embedded in the rear of the vehicle, the vehicle can be a kinetic-electric hybrid vehicle. If an internal combustion engine and a transmission drive the front wheels, the vehicle then becomes a four wheel drive fuel-kinetic-electric hybrid vehicle. The arrangement depicted in FIG. 6(b) is suitable for use with the third embodiment, using two groups of components 32 and 34 from FIG. 4(a). With two rear drive wheels that contain the group of components represented by 32 and two front drive wheels that contain the group of components represented by 34, the vehicle becomes a four wheel drive kinetic-electric hybrid vehicle. If this vehicle is equipped with an internal combustion engine and a transmission to also drive the front wheels, the vehicle becomes a four wheel drive fuel-kinetic-electric hybrid vehicle.

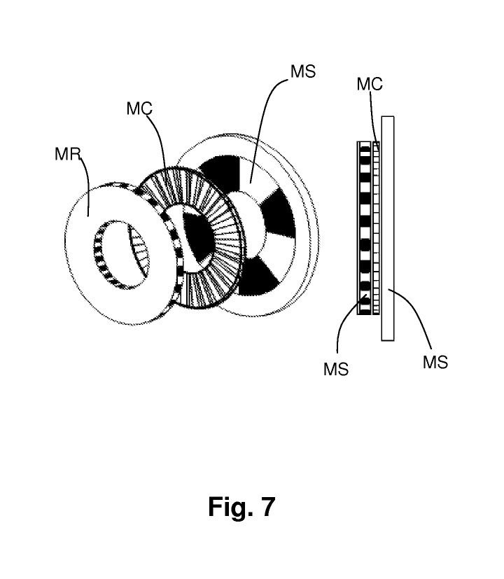

FIG. 7 introduces a set of magnetic gears that can be used in the present invention. The magnetic gears depicted have different quantities of permanent magnets arranged in a rotatable ring or disc to replace mechanical gears to transmit torque and power, with the advantages of no mechanical friction (since there are air gaps between the gears) and higher efficiency. A gear system similar to a three port planetary gear system can be comprised of magnetic gears. There are three major components that can be used as three input/output ports. The high speed magnetic pole rotor MS containing a lesser number of magnets in the magnetic gear system can function similarly to the sun gear S in a planetary gear system. The low speed magnetic pole rotor MR containing a larger number of magnets in the magnetic gear system can function similarly to the ring gear R in a planetary gear system. In between MS and MR lies a modulating ring or disc, which contains a number of ferrous magnetic flux conductors spaced apart from one another in a non-magnetic medium. This modulating ring or disc corresponds to MC in FIG. 7, and MC can function similarly to the planet carrier gear C in a planetary gear system. Although mechanical and magnetic planetary gear systems may behave similarly from a conceptual point of view, structurally they are distinct enough to warrant more description.

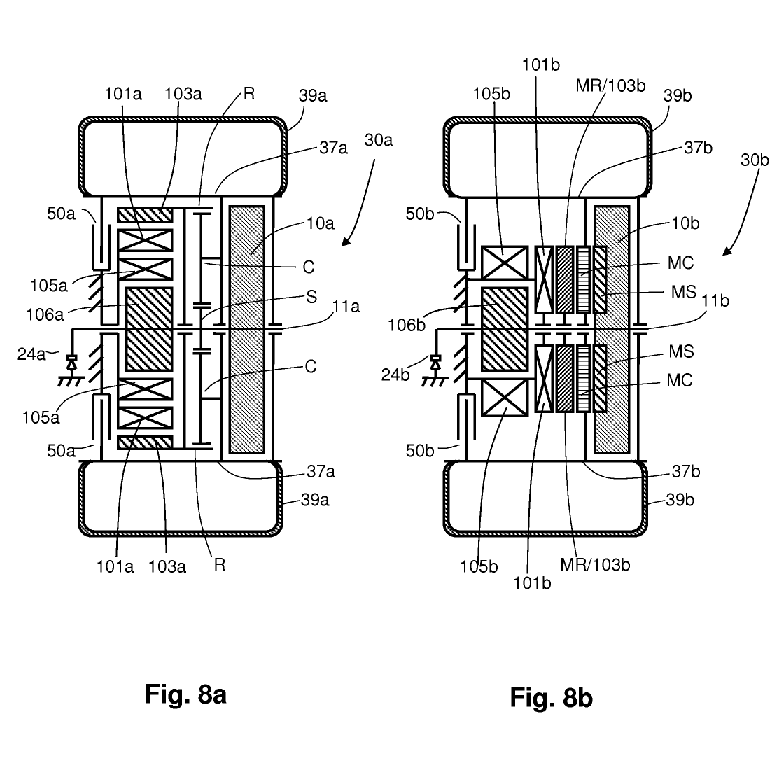

FIG. 8(a) is exactly the same as FIG. 1(b), the structural mechanical diagram of the first embodiment, placed here for easier comparison of the structural differences between a traditional, mechanical planetary gear system used in the present invention and a magnetic planetary gear system used in the present invention (FIG. 8(b)). In FIG. 8(b), the high speed rotor MS functionally equivalent to the sun gear S is directly connected to the flywheel 10b, and the low speed rotor MR functionally equivalent to the ring gear R is one and the same as the rotor 103b of the variator motor/generator 01. The modulating ring MC functionally equivalent to the planet carrier gear C is positioned in between MS and MR, as a part of the chamber containing the flywheel 10b, and directly connected to the wheel hub 37b. Thus, the three constituent gears of a planetary gear system have been integrated into either the motor/generator 01 or the flywheel 10b, both simplifying the mechanical structure of the system and increasing its power transmission efficiency by eliminating mechanical friction between the gears. The other components illustrated in FIG. 8(b) are connected in basically the same way as their equivalent components in FIG. 8(a). The stators 101b and 105b are both connected to the vehicle chassis, the rotor 106b of the motor/generator 02 is still connected to the flywheel 10b, and there is still a one way clutch 24b to prevent the flywheel 10b from rotating in the reverse direction as well as a mechanical brake 50.

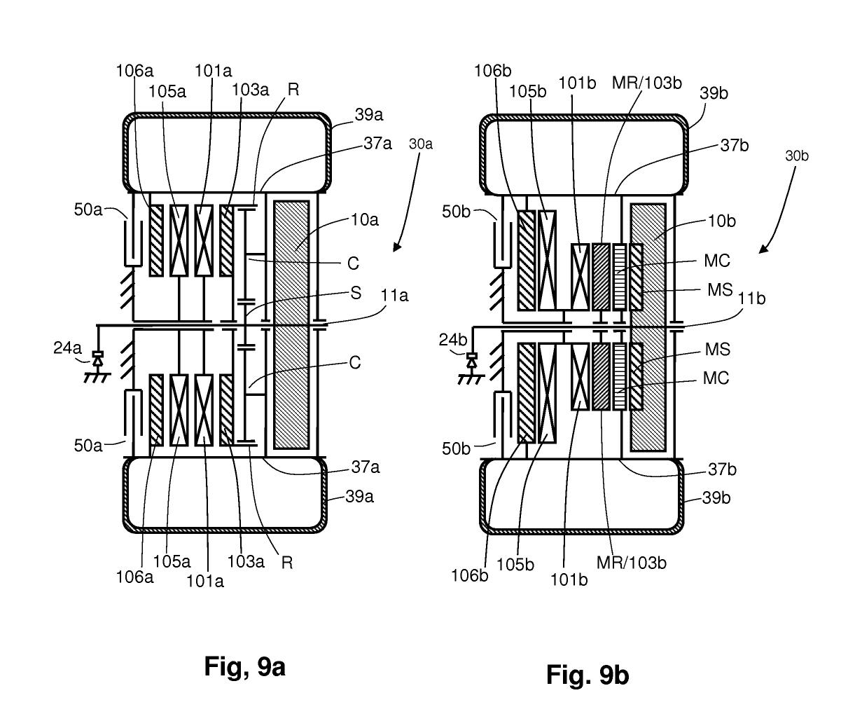

FIG. 9(b) illustrates the structure of the second embodiment of the present invention if a magnetic planetary gear system is used. In this case, the connections among the flywheel 10b, the rotor 103b and stator 101b of the motor/generator 01, and the magnetic gears MS, MR and MC are the same as what was shown in FIG. 8(b). The difference to note here is that the rotor 106b of the motor/generator 02 is connected to the wheel hub 37b and not to the flywheel 10b. FIGS. 9(a) and 9(b) can be controlled to be functionally equivalent.

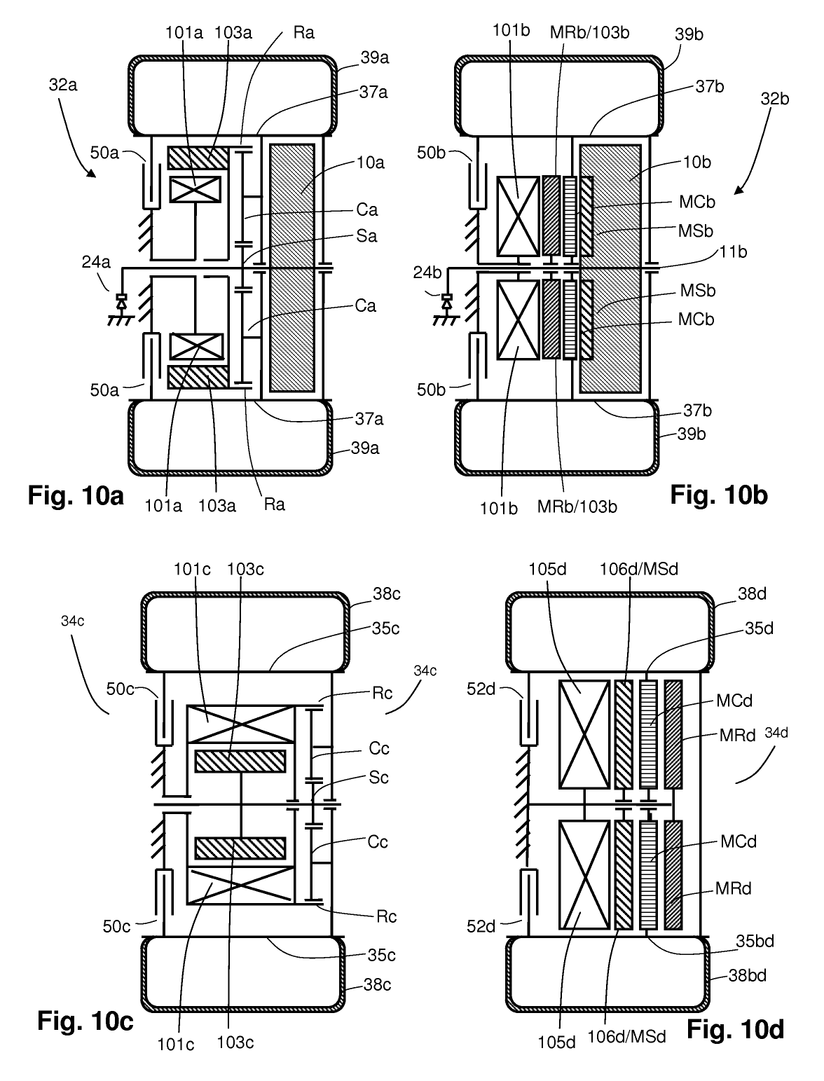

FIG. 10(b) depicts a magnetic planetary gear system implementation of the third embodiment. The connections among the flywheel 10b, the rotor 103b and stator 101b of the motor/generator 01, and the magnetic gears MS, MR and MC are the same as in FIGS. 8(b) and 9(b). The difference between the configurations in FIGS. 9(b) and 10(b) is that in FIG. 10(b) the motor/generator 02 has been installed in another wheel hub (not shown). FIGS. 10(a) and 10(b) both show the structure of the group of components represented by 32 in FIG. 4(a). FIG. 10(a) presents a configuration using a mechanical planetary gear system while FIG. 10(b) presents a configuration using a magnetic planetary gear system; the two configurations are functionally equivalent.

FIG. 10(c) shows an implementation of the second wheel hub of the third embodiment containing the group of components 34c, which includes the motor/generator 02, using a mechanical planetary gear system. FIG. 10(c) is functionally equivalent to the structure marked as 34 in FIG. 4(b), with the difference that 34c of FIG. 10(c) further incorporates a fixed speed ratio transmission comprised of a set of mechanical planetary gears. In FIG. 10(d), the transmission comprises magnetic planetary gears instead of mechanical planetary gears. The configuration of FIG. 10(d) has better transmission efficiency compared to that of FIG. 10(c).

The system of the present invention can be integrated easily into new or existing vehicles for improved fuel economy. Mechanical planetary gears provide a purely mechanical path for the exchange of kinetic energy between the flywheel and the vehicle, improving accelerative performance and regenerative braking capabilities. Magnetic planetary gears can be even more efficient at transmitting power than mechanical planetary gears due to the fact that they are contactless and frictionless.

What is claimed is:

1. A kinetic hybrid system in the wheel, comprising:
i. a first wheel for a vehicle having a connection to the vehicle chassis and a connection to the wheel rim;
ii. a planetary gear system contained within the wheel, the planetary gear system having a first port, a second port connected to the wheel rim, and a third port;
iii. a flywheel coupled to the first port of the planetary gear system;
iv. a first motor disposed in the first wheel and having a first rotor and a first stator, the first rotor being connected to the third port of the planetary gear system, and the first stator being connected to the vehicle chassis; and
v. a one-way clutch coupled to the first port of the planetary gear system, the one-way clutch being configured to be coupled to the vehicle chassis.

2. The system of claim 1, further comprising a second wheel having a connection to the vehicle chassis, a connection to the wheel rim, and a second motor disposed in the second wheel and having a second rotor and a second stator, the second rotor being connected to the wheel rim and the second stator being connected to the vehicle chassis, wherein the second wheel is operated simultaneously with the first wheel.

3. The system of claim 2, wherein the first wheel is situated at the rear of the vehicle and the second wheel is situated at the front of the vehicle.

4. The system of claim 3, further comprising a third wheel and a fourth wheel, wherein:
the third wheel is symmetrical to the first wheel, housing a planetary gear system, a flywheel, and a third motor having a third rotor and a third stator, wherein the first port of the planetary gear system is connected to the flywheel and to a one-way clutch configured to be connected to the vehicle chassis, the second port of the planetary gear system is connected to the wheel rim, the third port of the planetary gear system is connected to the third rotor, and the third stator is connected to the vehicle chassis; and
the fourth wheel is symmetrical to the second wheel, housing a fourth motor having a fourth rotor and a fourth stator, wherein the fourth rotor is connected to the fourth wheel rim and the fourth stator is connected to the vehicle chassis.

5. The system of claim 2, wherein the first stator connected to the vehicle chassis is contained inside the first rotor that is connected to the third port of the planetary gear system.

6. The system of claim 4, wherein the first and third stators connected to the vehicle chassis are respectively contained inside the first rotor and the third rotor in the first wheel and third wheel.

7. The system of claim 1, further comprising a second motor disposed in the first wheel and having a second rotor and a second stator, the second stator being connected to the vehicle chassis, and the second rotor being connected to one of the first port and the second port of the planetary gear system.

8. The system of claim 7, wherein the first stator connected to the vehicle chassis is contained inside the first rotor that is connected to the third port of the planetary gear system, and the second stator connected to the vehicle chassis is contained inside the first stator and encloses the second rotor connected to the first port of the planetary gear system.

9. The system of claim 8, further comprising a second wheel that is symmetric to the first wheel, having the same constituent components and the same connections between components.

10. The system of claim 9, wherein the first wheel and the second wheel are situated at the rear of the vehicle.

11. The system of claim 7, wherein the second rotor is connected to the wheel rim on the second port of the planetary gear system, and wherein the second stator and the first stator are positioned coaxially.

12. The system of claim 11, further comprising a second wheel that is symmetric to the first wheel, having the same constituent components and having the same connections between components.

13. The system of claim 12, wherein the first wheel and the second wheel are situated at the rear of the vehicle.

14. A method of operating a kinetic hybrid vehicle that includes a flywheel connected to a first port of a continuously variable transmission, a first motor connected to a third port of the continuously variable transmission, and a second motor and a wheel of the vehicle connected to the second port of the continuously variable transmission, the method comprising:
determining the vehicle speed in real-time, and selecting one of three operation states,
wherein the first operation state comprises operating the first motor on the third port of the continuously variable transmission to release energy from the flywheel on the first port to the wheel on the second port of the continuously variable transmission, or to store energy from the wheel on the second port to the flywheel on the first port, while the second motor is inactive,
the second operation state comprises operating the second motor on the second port of the continuously variable transmission to drive the wheel on the same port while the first motor is inactive and both the first port and the third port rotate freely, and
the third operation state comprises operating both the first motor and the second motor to drive the wheel on the second port of the continuously variable transmission.

15. A kinetic hybrid system in the wheel, comprising:
i. a wheel for a vehicle having a connection to the vehicle chassis and a connection to the wheel rim;
ii. a three port magnetic gear system contained within the wheel, the magnetic gear system having a first magnetic rotor having a first number of magnetic poles at the first port, a second magnetic rotor having a second number of magnetic poles at the third port, and a rotatable member at the second port comprised of a non-ferrous material having ferromagnetic pieces embedded, and positioned in between the first rotor and the second rotor, wherein the second port is connected to the wheel rim;
iii. a flywheel coupled to the first port of the magnetic gear system;
iv. a first motor disposed in the wheel and having a first rotor and a first stator, the first rotor being the second magnetic rotor connected to the third port of the magnetic gear system, and the first stator being connected to the vehicle chassis; and
v. a one-way clutch coupled to the first port of the magnetic gear system, the one-way clutch being configured to be coupled to the vehicle chassis.

16. The system of claim 15, wherein the first magnetic rotor, second magnetic rotor, and rotatable member at the second port of the magnetic gear system are coaxially driven.

17. The system of claim 16, wherein the first magnetic rotor, second magnetic rotor, and rotatable member at the second port of the magnetic gear system are positioned concentric to one another.

18. The system of claim 17, wherein the first magnetic rotor on the first port of the magnetic gear system is embedded within the flywheel connected to the first port.

19. The system of claim 15, further comprising a second motor disposed in the wheel and having a second rotor and a second stator, the second stator being connected to the vehicle chassis, and the second rotor being connected to one of the first port and the second port of the magnetic gear system, wherein the second rotor and the second stator are coaxially driven.

20. The system of claim 19, wherein the second stator and the second rotor of the second motor are concentric, the second rotor being contained inside the second stator.
